(19) United States
(12) Patent Application Publication
(10) Pub. No.: US 2026/0149753 A1
(43) Pub. Date: May 28, 2026

(54) SELECTIVE RESET AND CACHE-FLUSH OF REGISTERS AND MEMORY

(71) Applicant: Cisco Technology, Inc., San Jose, CA (US)

(72) Inventors: Vinod CHANDRAN, Newark, CA (US); Rajagopal VENKATRAMAN, San Jose, CA (US); Manas PATI, San Jose, CA (US); Lakshmi THANVANTRI, San Jose, CA (US); Shyamsundar N MANIYAR, San Jose, CA (US); Prasath ELANGOVAN, Cupertino, CA (US)

(21) Appl. No.: 18/962,469

(22) Filed: Nov. 27, 2024

(51) Int. Cl. G06F 12/0804

(52) U.S. Cl. CPC G06F 12/0804

(57) ABSTRACT

In one embodiment, a method for selective reset and cache-flush of registers and memory includes determining, by a process, characteristics of a plurality of network devices based on utilization of a plurality of hardware devices in a network and generating, by the process and based on the characteristics of the plurality of network devices, a plurality of profiles corresponding to subsets of the plurality of hardware devices. The method can further include selecting, by the process, a first subset of the plurality of hardware devices to perform an operation to update information written to registers of the first subset of the plurality of hardware devices and performing, by the process, the operation to update the information written to the registers of the first subset of the plurality of hardware devices.

### TECHNICAL FIELD

The present disclosure relates generally to computer networks, and, more particularly, to selective reset and cache-flush of registers and memory.

### BACKGROUND

Network switches and Internet-of-Things (IoT) switches are generally deployed in a single resource unit (RU) mode without hardware redundancy. As a result, installing software updates and/or upgrades on these types of devices can lead to network traffic downtime. However, minimizing traffic downtime can be crucial, particularly in sectors such as banking, healthcare, manufacturing factory floors, industrial automation, aviation, etc.

There are various current approaches to installing software updates and/or upgrades for network switches and/or IoT switches. One of these approaches can include reloading the software with a new image. Although this can be effective in providing updated and/or upgraded software to a network switch and/or IoT switch, there can be significant data path loss during the process. Another approach can include performing a “warm reload.” A warm reload can be used when the forwarding application-specific integrated circuit (ASIC) data pipeline remains unchanged in the new images, but minor fixes are performed in the control plane. As a result, a warm reload cannot be performed if the data plane is changed, limiting the use of this technique.

Yet another approach to installing software updates and/or upgrades for network switches and/or IoT switches is referred to as a “cache-and-flush mechanism.” The cache-and-flush mechanism can be used even if the ASIC data pipeline is changed in the new image. In general, the cache-and-flush mechanism results in around 5-30 seconds of data traffic downtime. Due to the relatively low downtime in comparison to other approaches, as well as the ability to be used even if the ASIC data pipeline is changed in the new image, the cache-and-flush mechanism is currently the most commonly utilized approach to installing software updates and/or upgrades for network switches and/or IoT switches.

### BRIEF DESCRIPTION OF THE DRA WINGS

The embodiments herein may be better understood by referring to the following description in conjunction with the accompanying drawings in which like reference numerals indicate identically or functionally similar elements, of which:

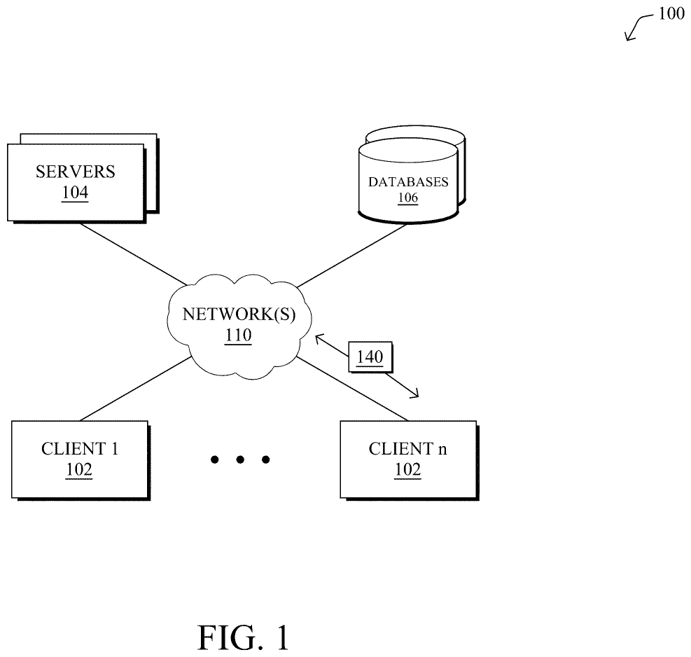

FIG. 1 illustrates an example computing system;

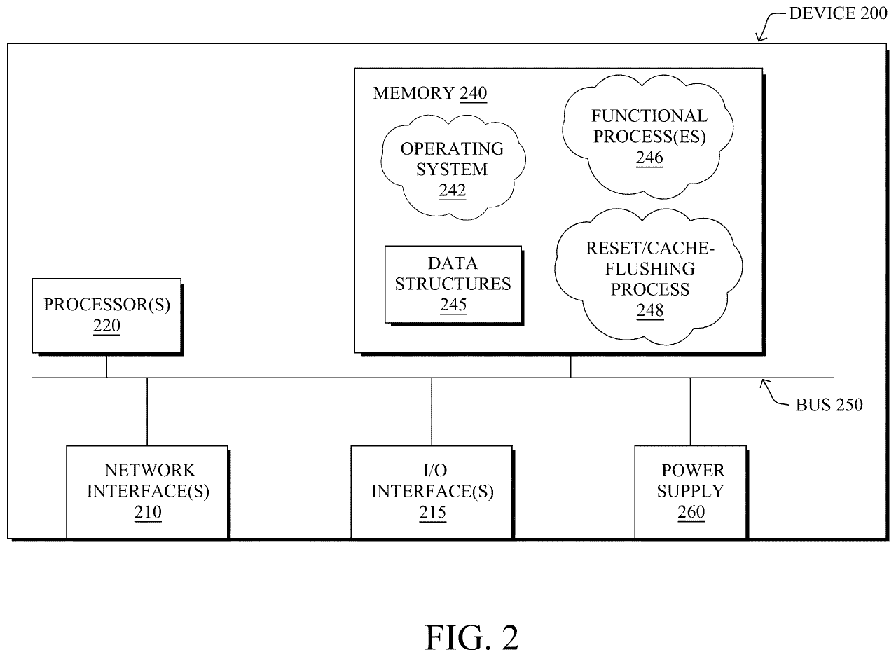

FIG. 2 illustrates an example network device/node;

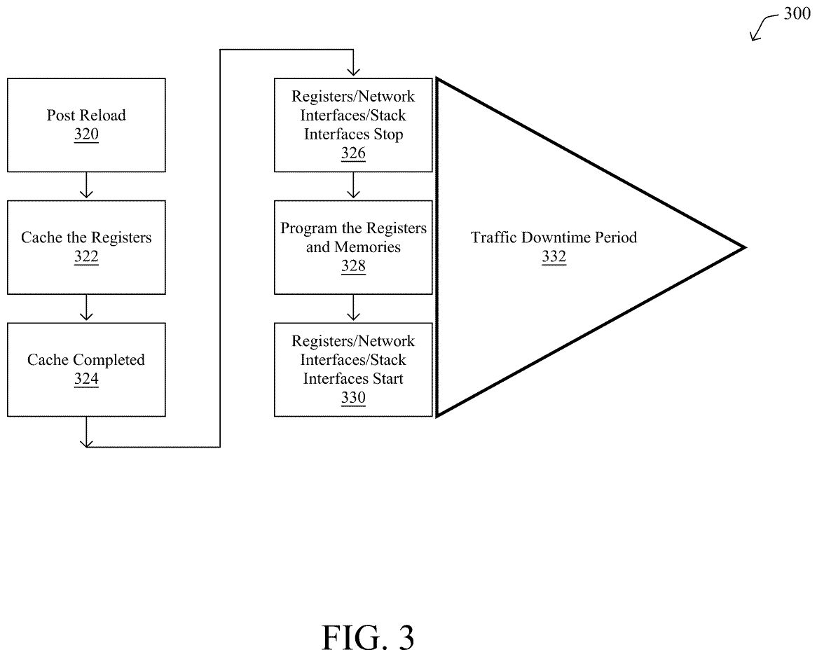

FIG. 3 illustrates an example flow for a cache-and-flush mechanism;

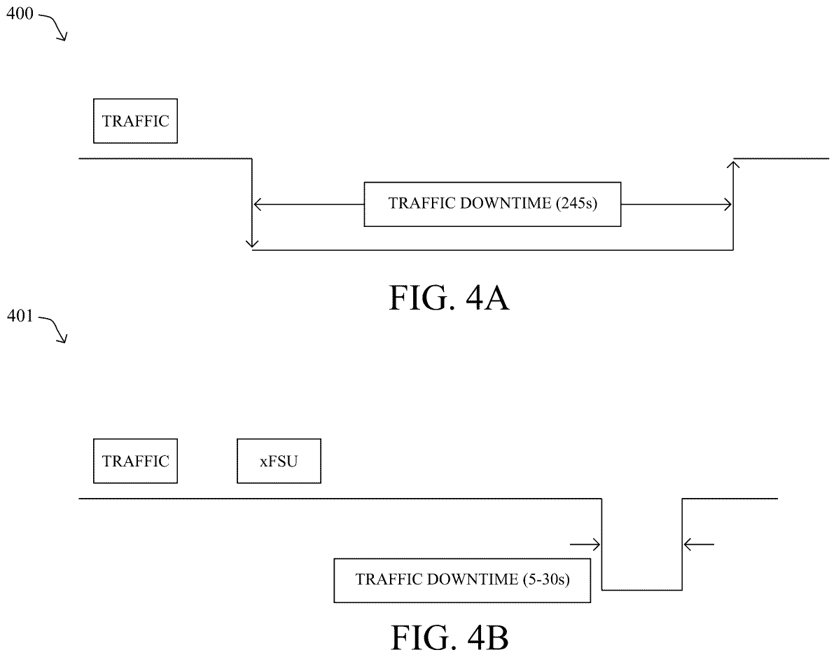

FIGS. 4A-4B illustrate example timing diagrams for installing software updates and/or upgrades for network switches and/or IoT switches;

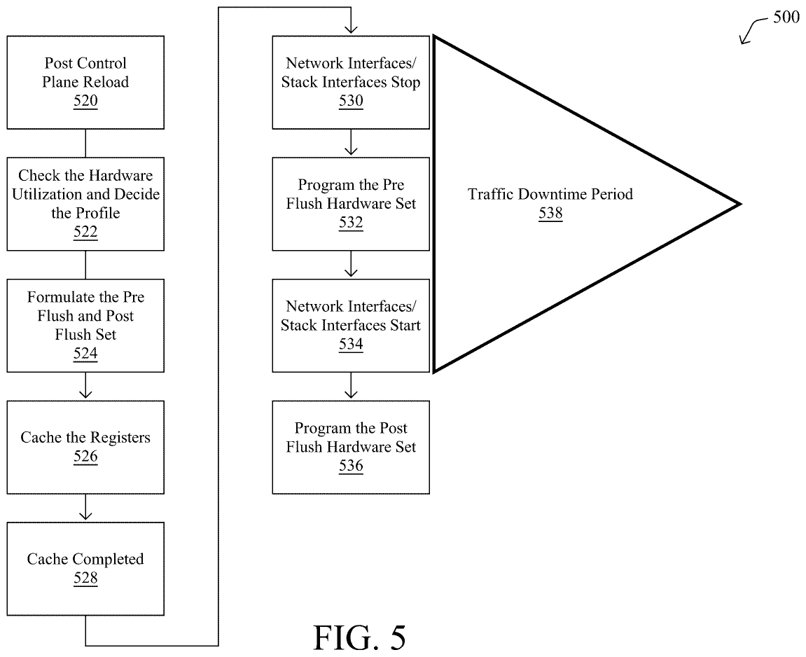

FIG. 5 illustrates an example flow for a selective reset and cache-flush of registers and memory in accordance with the disclosure;

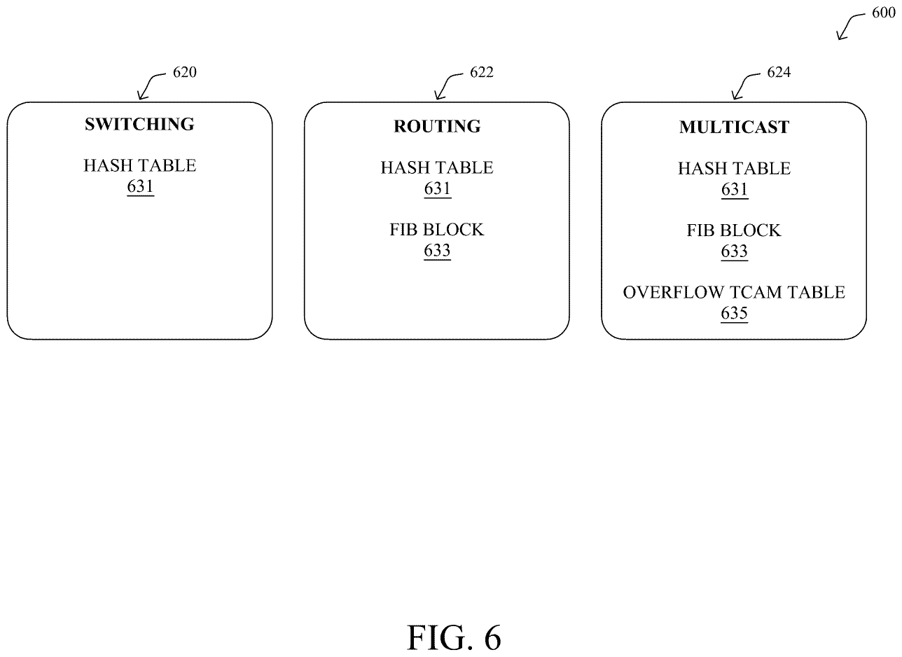

FIG. 6 illustrates an example of profiles for a selective reset and cache-flush of registers and memory in accordance with the disclosure;

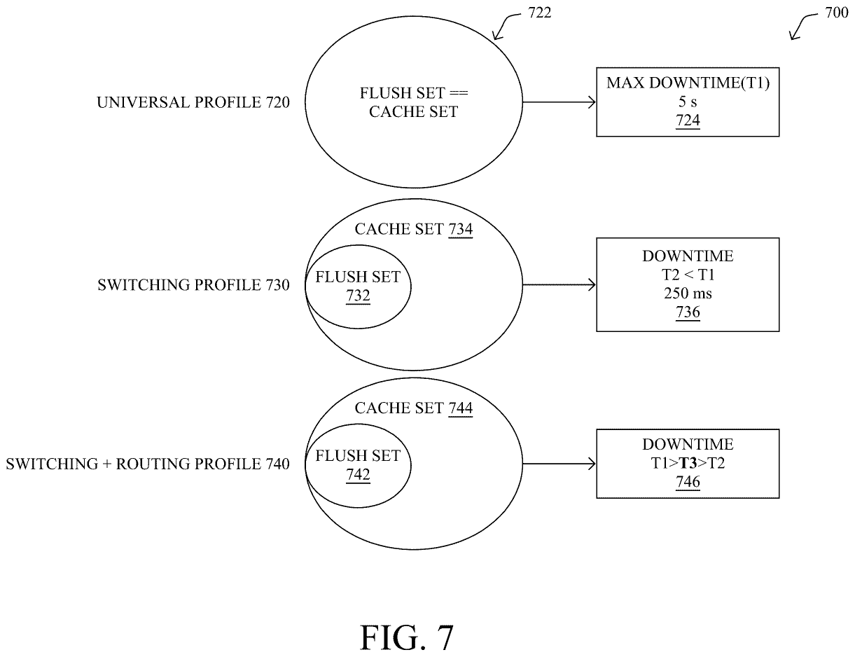

FIG. 7 illustrates an example of switching and switching plus routing profiles for a selective reset and cache-flush of registers and memory in accordance with the disclosure;

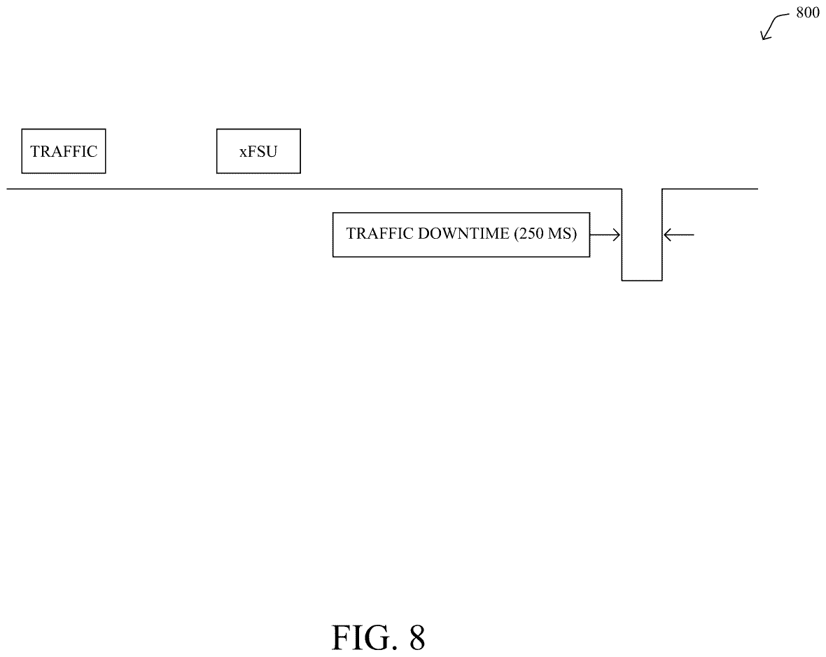

FIG. 8 illustrates an example timing diagram for a selective reset and cache-flush of registers and memory in accordance with the disclosure; and

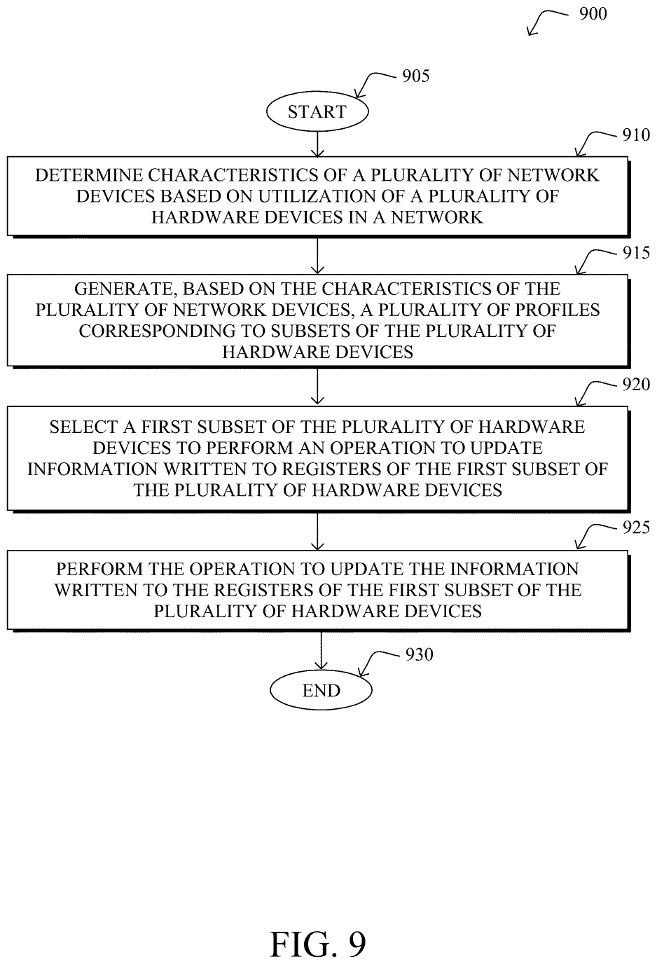

FIG. 9 illustrates an example procedure for a selective reset and cache-flush of registers and memory in accordance with the disclosure.

### DESCRIPTION OF EXAMPLE EMBODIMENTS

### Overview

According to one or more embodiments of the disclosure, a method for selective reset and cache-flush of registers and memory includes determining, by a process, characteristics of a plurality of network devices based on utilization of a plurality of hardware devices in a network and generating, by the process and based on the characteristics of the plurality of network devices, a plurality of profiles corresponding to subsets of the plurality of hardware devices. The method can further include selecting, by the process, a first subset of the plurality of hardware devices to perform an operation to update information written to registers of the first subset of the plurality of hardware devices and performing, by the process, the operation to update the information written to the registers of the first subset of the plurality of hardware devices.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc.

The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, forming a virtual connection between local networks and data center/cloud environments on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a reset/cache-flush process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, the one or more functional processes 246 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, one or more functional processes 246 and/or reset/cache-flush process (process 248) may include computer executable instructions that, when executed by processor(s) 220, cause device 200 to perform the techniques described herein. To do so, in some implementations, one or more functional processes 246 and/or process 248 may utilize machine learning.

Example machine learning techniques that one or more functional processes 246 and/or process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, one or more functional processes 246 and/or process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, one or more functional processes 246 and/or process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, one or more functional processes 246 and/or process 248 may be executed to intelligently route LLM workloads across executing nodes (e.g., communicatively connected GPUs clustered into domains).

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### ——Selective Reset and Cache-Flush of Registers and Memory——

FIG. 3 illustrates an example flow for a cache-and-flush mechanism. In some implementations, the cache-and-flush mechanism can be employed to reduce data traffic downtime, for example, in comparison to approaches that can include reloading the software with a new image and/or approaches that include performing a “warm reload.”

In the example of FIG. 3, the cache-and-flush mechanism can cache all updates from the control plane during reload and update phases of the software update and/or upgrade, preventing immediate updates to the data plane. Once the control plane reboots, the cache can be marked as complete, and the flush operation can be triggered. In general, the flush activity can include stopping network interfaces, resetting the hardware registers and memories, copying the cached data to the hardware registers and memories, and restarting network interfaces. However, as mentioned above, data traffic downtime during performance of this type of cache-and-flush mechanism can rage from 5-30 seconds.

Returning now to the example shown in FIG. 3, which illustrates that the duration from network interface stop to restart is directly impacted by the time taken to reprogram hardware elements, the flow 300 may begin at operation 320 where an instruction to perform a reload operation (e.g., an operation to begin a software update and/or upgrade) is received. In response to such an instruction, at operation 322, information written to registers (e.g., registers in the network devices that will undergo the operation to update and/or upgrade the software) may be cached. At operation 324, it may be determined that the caching of operation 322 is completed.

At operation 326, a command to stop activity associated with the registers, memory devices, network interfaces, and/or stack interfaces, etc. can be issued in preparation for programming the registers, memory devices, network interfaces, and/or stack interfaces, etc. At operation 328, the registers, memory devices, network interfaces, and/or stack interfaces, etc. can be programmed (e.g., the operation to update and/or upgrade the software associated with the network device can be performed). Subsequent to programming of the registers, memory devices, network interfaces, and/or stack interfaces, etc., at operation 330, the registers, memory devices, network interfaces, and/or stack interfaces, etc. can be re-initiated (e.g., started/brought back up), and the network device can operate again with the newly installed software updates and/or upgrades.

As shown in FIG. 3, the traffic downtime period 332 is determined by the amount of time it takes to perform operation 326, operation 328, and operation 330.

FIGS. 4A-4B illustrate example timing diagrams for installing software updates and/or upgrades for network switches and/or IoT switches. FIG. 4A illustrates a timing diagram 400 showing the traffic downtime for software updates and/or upgrades for network switches and/or IoT switches that include reloading the software with a new image, while FIG. 4B illustrates a timing diagram 401 showing the traffic downtime for the cache-and-flush mechanism described in FIG. 3.

In FIG. 4A, it is apparent that the traffic downtime for software updates and/or upgrades for network switches and/or IoT switches that include reloading the software with a new image can take minutes (e.g., around 245s (seconds)), which can be unacceptable in some deployments. Further, in FIG. 4B, it is apparent that the traffic downtime for software updates and/or upgrades for network switches and/or IoT switches that rely on the cache-and-flush mechanism described in FIG. 3 (e.g., an Extended Fast Software Upgrade (XFSU) mechanism) can take around 5-30 seconds to be completed. Although FIG. 4B illustrates a scenario that may be preferable to the amount of traffic downtime for software updates and/or upgrades for network switches and/or IoT switches shown in FIG. 4A, this amount of traffic downtime may also be unacceptable in some deployments.

As noted above, due to the relatively low downtime in comparison to other approaches, as well as the ability to be used even if the ASIC data pipeline is changed in the new image, the cache-and-flush mechanism and, more particularly, a cache-and-flush mechanism known as an Extended Fast Software Upgrade (XFSU), is currently the most commonly utilized approach to installing software updates and/or upgrades for network switches and/or IoT switches.

During extended fast software upgrades, traffic is generally disrupted for around seconds. This disruption is primarily due to the cleanup and reprogramming of hardware registers and memory. This issue affects standalone network devices and single-homed hosts on multi-node network devices. In general, the downtime is directly proportional to the number of elements processed during the reprogramming. Using current approaches, all hardware elements can be reprogrammed as a single exhaustive set, regardless of their actual utilization, which can lead to unnecessary reprogramming of elements that may already be in their default state.

For example, if two hash tables (e.g., a HashTable A and a HashTable B) are used for programming route table entries, on a VLAN-based access device that performs MAC address lookups, route table entries are not used. However, during performance of a software upgrade utilizing current approaches, cleaning up these hash tables still contributes to traffic downtime.

These and other deficiencies in current approaches can lead to the aforementioned downtime of around 30 seconds. However, 30 seconds of data traffic downtime associated with using the cache-and-flush mechanism to install software updates and/or upgrades for network switches and/or IoT switches may be too long, particularly in high utilization deployments where customers expect 24/7 network uptime. In such deployments (e.g., banking, healthcare, warehouses, manufacturing factory floors, AI-controlled operations, industrial automation, aviation, etc.), it may be desirable for traffic downtime to be sub-second and, in certain cases no more than 250 ms (milliseconds). In fact, extended downtime during upgrades could lead to significant collateral damage, potentially necessitating a complete shutdown of operations. Therefore, minimizing downtime during software upgrades is paramount.

The techniques herein, therefore, aim to reduce traffic downtime by profiling the network device based on its actual hardware utilization. By utilizing profiling and selective reprogramming techniques to selectively reprogram only the utilized elements, downtime can be significantly reduced. For example, as described in more detail herein, implementations of the present disclosure can reduce traffic downtime to sub-seconds (e.g., in the range of hundreds of milliseconds).

Specifically, according to one or more embodiments of the disclosure as described in detail below, a method for selective reset and cache-flush of registers and memory includes determining, by a process, characteristics of a plurality of network devices based on utilization of a plurality of hardware devices in a network and generating, by the process and based on the characteristics of the plurality of network devices, a plurality of profiles corresponding to subsets of the plurality of hardware devices. The method can further include selecting, by the process, a first subset of the plurality of hardware devices to perform an operation to update information written to registers of the first subset of the plurality of hardware devices and performing, by the process, the operation to update the information written to the registers of the first subset of the plurality of hardware devices.

Operationally, FIG. 5 illustrates an example flow for a selective reset and cache-flush of registers and memory mechanism in accordance with the disclosure. The flow 500 may begin at operation 520, where an instruction to perform a reload operation (e.g., an operation to begin a software update and/or upgrade) is received. In response to such an instruction, at operation 522, hardware utilization of components (e.g., registers, memory devices, etc.) can be determined and a profile (e.g., one of the profiles illustrated in FIG. 6, herein, among other possibilities) can be selected based on the hardware utilization.

At operation 524, a pre-flush set and a post-flush set can be determined. In general, the pre-flush set includes registers or portions of the registers in the network devices that will be updated first, while the post-flush set includes registers or portions of the registers that will be updated subsequent to performing updates to the pre-flush set. In some implementations, the pre-flush set can include registers that are experiencing greater than a threshold utilization (e.g., registers that are the “most used” based on the determined hardware utilization, as described in more detail in connection with Table 1, herein), while the post-flush set can target registers that are experiencing below the threshold hardware utilization. As discussed in more detail herein, updating devices associated with the pre-flush set separately (e.g., as opposed to a typical cache-and-flush mechanism where all the registers are updated during a same operation) can dramatically reduce the data traffic downtime associated with performing a software update and/or upgrade.

At operation 526, information written to registers (e.g., registers in the network devices that will undergo the operation to update and/or upgrade the software) may be cached. At operation 528, it may be determined that the caching of operation 526 is completed.

At operation 530, a command to stop activity associated with the registers, memory devices, network interfaces, and/or stack interfaces, etc. can be issued in preparation for programming the registers, memory devices, network interfaces, and/or stack interfaces, etc. targeted in accordance with the pre-flush operation.

At operation 532, the registers, memory devices, network interfaces, and/or stack interfaces, etc. targeted by the pre-flush set can be programmed (e.g., the operation to update and/or upgrade the software associated with the network device can be performed on the registers, etc. associated with the pre-flush operation).

Subsequent to programming of the registers, memory devices, network interfaces, and/or stack interfaces, etc. associated with the pre-flush set, at operation 534, the registers, memory devices, network interfaces, and/or stack interfaces, etc. can be re-initiated (e.g., started/brought back up), and the network device can operate again with the newly installed software updates and/or upgrades.

At operation 536, the post-flush set can be programmed. For example, at operation 536, the registers, memory devices, network interfaces, and/or stack interfaces, etc. associated with the post-flush set can, in response to one or more commands, be subjected to operations to update and/or upgrade the software associated with the registers, memory devices, network interfaces, and/or stack interfaces, etc. of the network device associated with the post-flush set.

As shown in FIG. 5, the traffic downtime period 538 is determined by the amount of time it takes to perform operation 530, operation 532, and operation 534.

Table 1 shows an example of hardware utilization in a VLAN-based network device with no routing or multicast. It will be appreciated that the example shown in Table 1 is merely illustrative and is not intended to limit the scope of the disclosure. That is, it will be appreciated that the numerical values given in Table 1, as well as the table types, subtypes, directories, etc. described in the columns and/or rows of Table 1 are merely illustrative and are intended to elucidate implementations of the disclosure.

TABLE 1

| TABLE | SUBTYPE | DIRECTORY | MAX | USED | % USED |
|---|---|---|---|---|---|
| MAC | EM | I | 32768 | 222 | 0.68% |
| Address | | | | | |
| table | | | | | |
| MAC | TCAM | I | 1024 | 22 | 2.15% |
| Address | | | | | |
| table | | | | | |
| L3 | EM | I | 8192 | 0 | 0.00% |
| Multicast | | | | | |
| L3 | TCAM | I | 512 | 9 | 1.76% |
| Multicast | | | | | |
| L2 | EM | I | 8192 | 0 | 0.00% |
| Multicast | | | | | |
| L2 | TCAM | I | 512 | 11 | 2.15% |
| Multicast | | | | | |
| IP Route | EM | I | 24576 | 3 | 0.01% |
| table | | | | | |
| IP Route | TCAM | I | 8192 | 9 | 0.23% |
| table | | | | | |

The non-limiting example shown in Table 1 shows content-addressable memory (CAM) utilization for an ASIC that is deployed in a network device in accordance with the disclosure. The example shown in Table 1 relates to a switch with no Layer 3 interfaces or multicast enabled, so the hardware components utilized will primarily be those involved in MAC address switching. For example, the example of Table 1 generally illustrates the utilization of a VLAN-based network device with no routing or multicast enabled, so the hardware elements used for IP routing and/or multicast can be programmed after enabling the network interfaces, without impacting the traffic flowing through the switch.

Stated alternatively, in accordance with the disclosure, a pre-flush set and a post-flush set can be determined based on hardware utilization and then these sets can be programmed individually (as discussed above in connection with FIG. 5) in order to reduce data traffic downtime. In some implementations, traffic downtime is reduced by characterizing the network device based on the utilization of hardware components such as TCAMs and registers. Hardware components that are either not enabled via configuration or are not used for switching/routing traffic may be identified as being closer to their default state and can be selectively bypassed during reprogramming.

In order to achieve this, the registers can be divided into two sets—the pre-flush set and the post-flush set, which can be programmed at different stages, separated by the network interface enablement. The cache-and-flush mechanism can analyze data and compute the pre-register sets in advance.

FIG. 6 illustrates an example of sets of profiles for a selective reset and cache-flush of registers and memory in accordance with the disclosure. The sets of profiles 600 shown in FIG. 6 can include a switching profile 620, a routing profile 622, and a multicast profile 624. These example profiles are shown for illustration purposes and are generally based on the most probably profiles that can be determined for a network switch. However, it will be appreciated that these example profiles are not intended to be limiting, and other profiles can be created based on characteristics of the network deployment.

In the non-limiting example of FIG. 6, the switching profile 620 can include a hash table 631. The hash table 631 can correspond to the MAC address table shown in row 2 of Table 1, above. The routing profile 622 can include the hash table 631, but also can include a forward information base (FIB) table, e.g., the FIB block 633. The multicast profile 624 can include the hash table 631, the FIB block 633, and an overflow TCAM table 635. Examples of registers that may include information corresponding to the routing profile 622 can be seen in rows 8-9 in Table 1, while examples of information corresponding to the multicast profile 624 can be seen in rows 4-7 of Table 1.

Accordingly, on a device, such as a network switch with a switching profile, the FIB block 633 and/or the overflow TCAM table 635 can be programmed after enabling the network interfaces. That is, on devices that can be characterized as having a switching profile, registers associated with the hash table 631 can be allocated to the pre-flush set and hence, can be programmed first, while registers associated with the FIB block 633 and/or the overflow TCAM table 635 can be allocated to the post-flush set and can therefore be programed after enabling the network interfaces (e.g., at operation 534).

FIG. 7 illustrates an example of switching and switching plus routing profiles for a selective reset and cache-flush of registers and memory in accordance with the disclosure. As shown in FIG. 7, a universal profile 720 can include a flush set 722 that includes the entire cache set. Accordingly, in some implementations, the universal profile can be applied during performance of a cache-and-flush operation in which the entire cache is flushed. As shown in FIG. 7 at block 724, this can lead to a maximum data traffic downtime (T1) of five seconds.

In addition, a switching profile 730 is shown in FIG. 7. In the example of FIG. 7, the switching profile 730 can include flush set 732 that is a subset of the cache set 734. In some implementations, the flush set 732 can be smaller (e.g., can include fewer registers) than the flush set 742. This feature can allow for, as shown at block 736, for a data traffic downtime (T2) of around 250 ms (milliseconds). That is, selecting the flush set 732 to be relatively small, as discussed above, can allow for a data traffic downtime less than the data traffic downtime associated with the universal profile 720 (e.g., T2<T1).

In addition, a switching plus routing profile 740 is shown in FIG. 7. In the example of FIG. 7, the switching plus routing profile 740 can include flush set 742 that is a subset of the cache set 744. In some implementations, the flush set 742 can be larger (e.g., can include a greater number of registers) than the flush set 732. This feature can allow for, as shown at block 746, for a data traffic downtime (T3) that is between the data traffic downtime T1 and the data traffic downtime T2 (e.g., T1>T3>T2).

It is further noted that a network device these profiles (e.g., the universal profile 720, the switching profile 730, and the switching plus routing profile 740, among others) based on the hardware utilization of various components in the network device and/or various feature lists associated with the network device. In addition, each of the profiles can be mapped to a specific list of hardware elements associated with the network device.

FIG. 8 illustrates an example timing diagram for a selective reset and cache-flush of registers and memory in accordance with the disclosure. In FIG. 8, it is apparent that the traffic downtime for software updates and/or upgrades for network switches and/or IoT switches that rely on the techniques described herein (e.g., an Extended Fast Software Upgrade (XFSU) mechanism that utilizes a selective reset and cache-flush of registers and memory paradigm) can take around 250 ms (milliseconds) to be completed.

In closing, FIG. 9 illustrates an example simplified procedure for a selective reset and cache-flush of registers and memory in accordance with one or more embodiments described herein, particularly from the perspective of a device. In some implementations, the procedure can be for selective reset and cache-flush of registers and memory based on hardware utilization to minimize traffic downtime during software upgrades and reloads. For example, a non-generic, specifically configured device (e.g., device 200, an apparatus) may perform procedure 900 by executing stored instructions (e.g., process 248). The procedure 900 may start at step 905, and continues to step 910, where, as described in greater detail above, characteristics of a plurality of network devices based on utilization of a plurality of hardware devices in a network are determined. In some implementations, the plurality of network devices can be deployed in a high-uptime environment (e.g., an environment that operates 24/7 or near-24/7, or an environment that requires near 99% uptime or greater, such as banking, healthcare, warehouses, manufacturing factory floors, AI-controlled operations, industrial automation, aviation, etc. deployments).

The procedure 900 may continue to step 915, where, as described in greater detail above, a plurality of profiles corresponding to subsets of the plurality of hardware devices are generated based on the characteristics of the plurality of network devices. In some implementations, the plurality of profiles can include at least a switching profile, a routing profile, and a multicast profile. In such implementations, the switching profile can include at least a hash table, the routing profile can include at least the hash table and a forwarding information base, and the switching profile can include at least the hash table, the forwarding information base, and a ternary content-addressable memory table.

The procedure 900 may continue to step 920, where, as described in greater detail above, a first subset of the plurality of hardware devices are selected to perform an operation to update information written to registers of the first subset of the plurality of hardware devices. In some implementations, the first subset of the plurality of hardware devices can include hardware devices that are characterized by a highest utilization of hardware resources among the plurality of hardware devices.

The procedure 900 may continue to step 925, where, as described in greater detail above, the operation to update the information written to the registers of the first subset of the plurality of hardware devices is performed. In some implementations, the operation can include at least a portion of a cache-flush operation. In some implementations, the operation to update the information written to the registers of the first subset of the plurality of hardware devices is performed in two hundred and fifty milliseconds or less.

In some implementations, the procedure 900 can further include performing a second operation to update the information written to registers of a second subset of the plurality of hardware devices. In such implementations, the procedure 900 can further include performing a third operation to update the information written to registers of a third subset of the plurality of hardware devices.

As discussed above, in some implementations, the procedure 900 can further include performing an operation to cache information in the first subset of the plurality of hardware devices prior to performing the operation to update the information written to the registers of the first subset of the plurality of hardware devices, causing a suspension of network interface activity prior to performing the operation to update the information written to the registers of the first subset of the plurality of hardware devices, and resuming the network interface activity subsequent to performing the operation to update the information written to the registers of the first subset of the plurality of hardware devices.

Procedure 900 may end at step 930.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: determining characteristics of a plurality of network devices based on utilization of a plurality of hardware devices in a network; generating, based on the characteristics of the plurality of network devices, a plurality of profiles corresponding to subsets of the plurality of hardware devices; selecting a first subset of the plurality of hardware devices to perform an operation to update information written to registers of the first subset of the plurality of hardware devices; and performing the operation to update the information written to the registers of the first subset of the plurality of hardware devices.

In still other implementations, a tangible, non-transitory, computer-readable medium storing program instructions that cause a device to execute a process comprising: determining, by a process, characteristics of a plurality of network devices based on utilization of a plurality of hardware devices in a network; generating, by the process and based on the characteristics of the plurality of network devices, a plurality of profiles corresponding to subsets of the plurality of hardware devices; selecting, by the process, a first subset of the plurality of hardware devices to perform an operation to update information written to registers of the first subset of the plurality of hardware devices; and performing, by the process, the operation to update the information written to the registers of the first subset of the plurality of hardware devices.

The techniques described herein, therefore, provide for selective reset and cache-flush of registers and memory based on hardware utilization to minimize traffic downtime during software upgrades and reloads. As discussed above, the techniques described herein can reduce traffic downtime by profiling the network device based on its actual hardware utilization to selectively reprogram only the utilized elements, downtime can be significantly reduced. These and other techniques of the present disclosure can reduce traffic downtime from tens of seconds to sub-seconds (e.g., in the range of hundreds of milliseconds).

Illustratively, the techniques described herein may be performed by hardware, software, and/or firmware, (e.g., an “apparatus”) such as in accordance with the reset/cache-flush process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

Additionally, various aspects of the embodiments above may utilize various facets of machine learning and/or artificial intelligence to perform certain steps described above. For instance, embodiments herein may have a software process specifically configured to observe traffic patterns to then establish the corresponding profiles using ML/AI techniques, as may be appreciated by those skilled in the art.

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
determining, by a process, characteristics of a plurality of network devices based on utilization of a plurality of hardware devices in a network;
generating, by the process and based on the characteristics of the plurality of network devices, a plurality of profiles corresponding to subsets of the plurality of hardware devices;
selecting, by the process, a first subset of the plurality of hardware devices to perform an operation to update information written to registers of the first subset of the plurality of hardware devices; and
performing, by the process, the operation to update the information written to the registers of the first subset of the plurality of hardware devices.

2. The method of claim 1, wherein the operation comprises at least a portion of a cache-flush operation.

3. The method of claim 1, further comprising:
performing, by the process, a second operation to update the information written to registers of a second subset of the plurality of hardware devices.

4. The method of claim 3, further comprising:
performing, by the process, a third operation to update the information written to registers of a third subset of the plurality of hardware devices.

5. The method of claim 1, wherein the first subset of the plurality of hardware devices comprises hardware devices that are characterized by a highest utilization of hardware resources among the plurality of hardware devices.

6. The method of claim 1, wherein the plurality of profiles include at least a switching profile, a routing profile, and a multicast profile.

7. The method of claim 6, wherein:
the switching profile includes at least a hash table,
the routing profile includes at least the hash table and a forwarding information base, and
the switching profile includes at least the hash table, the forwarding information base, and a ternary content-addressable memory table.

8. The method of claim 1, wherein the operation to update the information written to the registers of the first subset of the plurality of hardware devices is performed in two hundred and fifty milliseconds or less.

9. The method of claim 1, wherein the plurality of network devices are deployed in a high-uptime environment.

10. The method of claim 1, further comprising:
performing, by the process, an operation to cache information in the first subset of the plurality of hardware devices prior to performing the operation to update the information written to the registers of the first subset of the plurality of hardware devices;
causing, by the process, a suspension of network interface activity prior to performing the operation to update the information written to the registers of the first subset of the plurality of hardware devices; and
resuming, by the process, the network interface activity subsequent to performing the operation to update the information written to the registers of the first subset of the plurality of hardware devices.

11. An apparatus, comprising:
one or more network interfaces to communicate with a network;
a processor coupled to the one or more network interfaces and configured to execute one or more processes; and
a memory configured to store a process that is executable by the processor, the process comprising:
determining characteristics of a plurality of network devices based on utilization of a plurality of hardware devices in a network;
generating, based on the characteristics of the plurality of network devices, a plurality of profiles corresponding to subsets of the plurality of hardware devices;
selecting a first subset of the plurality of hardware devices to perform an operation to update information written to registers of the first subset of the plurality of hardware devices; and
performing the operation to update the information written to the registers of the first subset of the plurality of hardware devices.

12. The apparatus of claim 11, further comprising:
performing, by the process, a second operation to update the information written to registers of a second subset of the plurality of hardware devices.

13. The apparatus of claim 12, further comprising:
performing, by the process, a third operation to update the information written to registers of a third subset of the plurality of hardware devices.

14. The apparatus of claim 11, wherein the first subset of the plurality of hardware devices comprises hardware devices that are characterized by a highest utilization of hardware resources among the plurality of hardware devices.

15. The apparatus of claim 11, wherein the plurality of profiles include at least a switching profile, a routing profile, and a multicast profile.

16. The apparatus of claim 15, wherein:
the switching profile includes at least a hash table,
the routing profile includes at least the hash table and a forwarding information base, and
the switching profile includes at least the hash table, the forwarding information base, and a ternary content-addressable memory table.

17. The apparatus of claim 11, wherein the operation to update the information written to the registers of the first subset of the plurality of hardware devices is performed in two hundred and fifty milliseconds or less.

18. The apparatus of claim 11, wherein the plurality of network devices are deployed in a high-uptime environment.

19. The apparatus of claim 11, further comprising:
performing, by the process, an operation to cache information in the first subset of the plurality of hardware devices prior to performing the operation to update the information written to the registers of the first subset of the plurality of hardware devices;
causing, by the process, a suspension of network interface activity prior to performing the operation to update the information written to the registers of the first subset of the plurality of hardware devices; and
resuming, by the process, the network interface activity subsequent to performing the operation to update the information written to the registers of the first subset of the plurality of hardware devices.

20. A tangible, non-transitory, computer-readable medium storing program instructions that cause a device to execute a process comprising:
determining characteristics of a plurality of network devices based on utilization of a plurality of hardware devices in a network;
generating, based on the characteristics of the plurality of network devices, a plurality of profiles corresponding to subsets of the plurality of hardware devices;
selecting a first subset of the plurality of hardware devices to perform an operation to update information written to registers of the first subset of the plurality of hardware devices; and
performing the operation to update the information written to the registers of the first subset of the plurality of hardware devices.
